(19) United States
(12) Patent Application Publication
(10) Pub. No.: US 2006/0035091 A1
(43) Pub. Date: Feb. 16, 2006

(54) Use of hyperbranched polymers comprising urethane and or urea groups for modifying Surfaces

(75) Inventors: Bernd Bruchmann, Freinsheim (DE); Helmut Meffert, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/532,247

(22) PCT Filed: Oct. 24, 2003
(86) PCT No.: PCT/EP03/11824

§ 371 Date: Apr. 22, 2005

(30) Foreign Application Priority Data
Oct. 25, 2002 (DE) 102 49 841.5

(51) Int. Cl. B32B 27/40

(52) U.S. Cl. 428/423.1

(57) ABSTRACT

The present invention relates to substrates whose surface comprises a hyperbranched polymer which has urethane groups and/or urea groups, its amount being appropriate for modifying the properties on the surface. The invention further relates to a process for modifying the surface properties of substrates.

The present invention relates to substrates whose surface comprises a hyperbranched polymer which has urethane groups and/or urea groups, its amount being appropriate for modifying the properties on the surface. The invention further relates to a process for modifying the surface properties of substrates.

The surface properties of natural and synthetic materials are substantially determined by affinity to water. Predominantly hydrophilic materials have a high level of interaction with water and generally with other polar solvents, whereas predominantly hydrophobic materials are not wetted, or only slightly wetted, by water and aqueous liquids. The surface properties of a material often restrict the scope for using and treating the material to an extent which makes modification desirable. This modification to increase affinity to water (hydrophilic properties) is termed hydrophilicization, whereas an improvement in water-repellancy properties is termed hydrophobicization.

Articles made from various synthetic materials, such as thermosets or thermoplastics, have hydrophobic surface properties. However, hydrophobic properties are often undesirable if adhesives, coatings, prints, dyes, or paints are to be applied to them, because most adhesives, coating compositions, and paints have inadequate adhesion to hydrophobic surfaces. Hydrophobic properties are also undesirable on sheet-like textiles, e.g. in particular nonwovens. Examples of the uses of nonwovens are cleaning cloths, wiping cloth, dishcloths, and napkins. In these applications it is important that when spilt liquids, such as milk, coffee, etc., are wiped up they are rapidly and completely absorbed, and that wet surfaces are dried to the maximum possible extent. The absorption of liquids by a cleaning cloth becomes faster as their rate of transport on the surface of the fibers increases, and fibers with a hydrophilic surface are readily and quickly wetted by aqueous liquids.

There are various conventional processes for hydrophilicizing the surfaces of films or of moldings. For example, the surfaces of plastic items can be activated by gaseous fluorine. However, this process requires operations using the highly poisonous gas fluorine, with increased apparatus costs. Corona and plasma treatments are other processes used to increase the hydrophilic character of the surface of various materials, such as plastics or metals.

To improve the water-absorption properties of, for example, nonwovens, use is also made of surface-active hydrophilicizing agents, such as emulsifiers, surfactants, or wetting agents. These give excellent initial hydrophilic properties. However, a disadvantage of these nonwovens is that the hydrophilic agents are gradually washed out by water or other aqueous media. After repeated contact with water, the product becomes increasingly hydrophobic. Another disadvantage of the known surface-active agents is a marked reduction in the surface tension of water, with the result that in many applications, in particular in nonwovens used for sanitary or diaper applications, there is an undesirable increase in susceptibility to permeation, and in the wetting power of the liquid absorbed.

Examples of hydrophobicizing modification of surface properties are provided by naturally occurring surfaces or surfaces produced from natural sources, e.g. wood, leather, paper, plaster, or concrete, with the aim of protecting them from water penetration. Wood can be protected from rot by controlled adjustment of water absorption. Leather for clothing is treated so that water runs off the surface, thus increasing wearer comfort. Surfaces of hydrophilic synthetic materials can also be hydrophobicized.

WO 98/27263 discloses polymer coatings with stable hydrophilic properties for polyester fibers, polypropylene fibers, and similar fibers. The coating comprises certain polyoxypropylamines or polypropylene oxide polymers, and hydrophilic polyester copolymers containing ethylene terephthalate units.

WO 97/00351 describes polymer coatings with longlasting hydrophilic properties for polyester, polyethylene or polypropylene fibers or fabrics comprising hydrophilic copolyesters and comprising polypropylene oxide polymers.

PCT/EP01/06719 describes the use of polymers which have urethane groups and/or urea groups, and ammonium groups, for modifying the surface properties of particulate, linear, sheet-like, or three-dimensional structures.

PCT/EP02/02201 describes the use of polymers which have urethane groups and/or urea groups, and anionic groups, the content of urethane groups and/or urea groups being at least 2 mol/kg, for modifying the surface properties of particulate, linear, sheet-like, or three-dimensional structures.

Both of the polyurethanes and/or polyureas used in the last-mentioned documents are not hyperbranched polymers.

WO 97/02304 describes highly functionalized polyurethanes and a process for their preparation. A possible application mentioned is use as a high-functionality crosslinking agent for polyurethane lacquers and polyurethane coatings, or for polyurethane foams.

U.S. Pat. No. 5,936,055 describes acid-functionalized polyurethane adducts with a branched structure. These are suitable for preparing crosslinked aqueous polymer latices, these being suitable for paints.

DE-A-199 04 444 describes a process for preparing dendrimers or highly branched polyurethanes which are suitable as compatibilizers, flow modifiers, agents providing thixotropic properties, nucleating reagents, or as an active ingredient carrier or catalyst support.

DE-A-100 13 187 describes a process for preparing high-functionality polyisocyanates which are suitable as a component for polyurethane preparation. The resultant polyurethanes may be used for producing lacquers, coatings, adhesives, sealing compounds, pourable elastomers, or foams, for example. Use of the high-functionality polyisocyanates per se for modifying the surface properties of substrates is not described.

DE-A-100 30 869 describes a process for preparing multifunctional polyisocyanate polyaddition products which are suitable as a component for preparing polyurethane. The resultant polyurethanes may be used for producing lacquers, coatings, adhesives, sealing compounds, pourable elastomers, or foams. This document again does not describe use of the polyisocyanate polyaddition products per se for modifying the surface properties of substrates.

The unpublished German patent application P 102 04 979.3 describes a process for preparing high-functionality highly branched polyureas. These are suitable as adhesion promoters or agents providing thixotropic properties, for example, or as components for producing lacquers, coatings, adhesives, sealing compounds, pourable elastomers, or foams.

It is an object of the present invention to provide substrates with specifically modified surface properties. These modified substrates are to have the desired property profile with respect to their affinity for water and for water-containing liquids (hydrophilic or hydrophobic properties). A further object on which the invention is based is to provide a process for increasing the level of hydrophilic or hydrophobic properties of the surface of substrates.

We have found that this object is achieved by way of a substrate whose surface comprises at least one hyperbranched polymer which has urethane groups and/or urea groups.

Suitable substrates generally encompass particulate, linear, sheet-like, or three-dimensional structures.

The term “particulate structures” encompasses the range from the fine pigments through macroscopic particles. Examples of particles included here are those whose size is from 1 nm to 10 mm, for example from 10 nm to 1 mm, specifically from 1 μm to 0.1 mm, preferably dispersed or dispersible in a medium. Examples which may be mentioned are pigments, mineral or metallic fillers, and non-living organic materials.

“Linear structures” are in particular fibers, filaments, yarns, and the like.

“Sheet-like structures” are in particular wovens, knits, felts, and nonwovens or nonwoven fabrics, the latter being preferred. To produce a nonwoven fabric, a set of fibers (nonwoven) is first laid down, and this is then consolidated by various methods to give nonwoven fabrics. For example, the nonwoven is treated with an aqueous binder, e.g. a polymer latex, and then, where appropriate after removal of excess binder, dried and, where appropriate, cured. Other sheet-like structures are films, paper, and comparable two-dimensional structures.

For the purposes of the present invention, “sheet-like textiles” also includes textile composites, e.g. carpets, laminated textiles, etc.

“Three-dimensional structures” are generally moldings, the dimensions of which vary greatly. These include in particular moldings made from wood, from paper, from metal, from plastics, from ceramic supports, or from webs made from natural or synthetic fibers, in the form of fluffs, tissues, etc.

Preferred embodiments of the structure of the invention are linear or sheet-like textiles. Other preferred embodiments of the structure of the invention are plastic films and plastic moldings.

The structures used according to the invention preferably encompass at least one natural or synthetic polymeric material.

Examples of these materials are:

1. Polymers of mono- and diolefins, for example polypropylene, polyisobutylene, poly-1-butene, poly-4-methyl-1-pentene, polyisoprene, and polybutadiene, and also polymers of cycloolefins, e.g. of cyclopentene or norbornene; also polyethylene (which may, where appropriate, have been crosslinked), e.g. high-density polyethylene (HDPE), high-density high-molecular-weight polyethylene (HDPE-HMW), high-density ultra-high-molecular-weight polyethylene (HDPE-UHMW), medium-density polyethylene (MDPE), low-density polyethylene (LDPE), linear low-density polyethylene (LLDPE), and branched low-density polyethylene (VLDPE).
Polyolefins, i.e. the monoolefin polymers mentioned by way of example in the section above, in particular polyethylene and polypropylene, may be prepared by various processes, in particular free-radical processes, or by way of a catalyst, the catalyst usually comprising one or more metals of group IVb, Vb, VIb, or VIII. These catalyst systems are usually termed Phillips, Standard Oil Indiana, Ziegler(-Natta), TNZ (DuPont), metallocene, or single-site catalysts (SSC).

2. Mixtures of the polymers mentioned in 1., e.g. mixtures of polypropylene with polyisobutylene, polypropylene with polyethylene (e.g. PP/HDPE, PP/LDPE), and mixtures of different polyethylene grades (e.g. LDPE/HDPE).

3. Copolymers of mono- and diolefins with one another or with other vinyl monomers, e.g. ethylene-propylene copolymers, linear low-density polyethylene (LLDPE), and mixtures of the same with low-density polyethylene (LDPE), propylene-1-butene copolymers, propylene-isobutylene copolymers, ethylene-1-butene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and copolymers of these with carbon monoxide, and ethylene-acrylic acid copolymers and salts of these (ionomers), and also terpolymers of ethylene with propylene and with a diene, such as hexadiene, dicyclopentadiene, or ethylidenenorbornene; also mixtures of these copolymers with one another, or with polymers mentioned in 1., e.g. polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers, and alternating-structure or random-structure polyalkylene-carbon monoxide copolymers, and mixtures of these with other polymers, e.g. with polyamides.

4. Hydrocarbon resins, including hydrogenated modifications of these (e.g. tackifier resins), and mixtures of polyalkylenes and starch.

5. Polystyrene, poly(p-methylstyrene), poly(α-methylstyrene).

6. Copolymers of styrene or α-methylstyrene with dienes or with acrylic derivatives, e.g. styrene-butadiene, styrene-acrylonitrile, styrene-alkyl methacrylate, styrene-butadiene-alkyl acrylate, styrene-butadiene-alkyl methacrylate, styrene-maleic anhydride, styrene-acrylonitrile-methyl acrylate; mixtures with high impact strength made from styrene copolymers with another polymer, e.g. with a polyacrylate, with a diene polymer, or with an ethylene-propylene-diene terpolymer; and block copolymers of styrene, e.g. styrene-butadiene-styrene, styrene-isoprene-styrene, styrene-ethylene/butylene-styrene, and styrene-ethylene/propylene-styrene.

7. Graft copolymers of styrene or α-methylstyrene, e.g. styrene on polybutadiene, styrene on polybutadiene-styrene copolymers, styrene on polybutadiene-acrylonitrile copolymers, styrene and acrylonitrile (and, respectively, methacrylonitrile) on polybutadiene; styrene, acrylonitrile, and methyl methacrylate on polybutadiene; styrene and maleic anhydride on polybutadiene; styrene, acrylonitrile, and maleic anhydride or maleimide on polybutadiene; styrene and maleimide on polybutadiene, styrene and alkyl acrylates and, respectively, alkyl methacrylates on polybutadiene, styrene and acrylonitrile on ethylene-propylene-diene terpolymers, styrene and acrylonitrile on polyalkyl acrylates or on polyalkyl methacrylates, styrene and acrylonitrile on acrylate-butadiene copolymers, and also mixtures of these with the copolymers mentioned in 6., e.g. those known as ABS polymers, MBS polymers, ASA polymers, or AES polymers.

8. Halogen-containing polymers, e.g. polychloroprene, chlorinated rubber, chlorinated and brominated isobutylene-isoprene copolymer (halobutyl rubber), chlorinated or chlorosulfonated polyethylene, copolymers of ethylene with chlorinated ethylene, epichlorohydrin homo- and copolymers, and in particular polymers of halogen-containing vinyl compounds, e.g. polyvinyl chloride, polyvinylidene chloride, polyvinyl fluoride, polyvinylidene fluoride; and copolymers of these, such as vinyl chloride-vinylidene chloride, vinyl chloride-vinyl acetate, and vinylidene chloride-vinyl acetate.

9. Polymers derived from α,β unsaturated acids or from derivatives of these, for example polyacrylates and polymethacrylates, butyl-acrylate-impact-modified polymethyl methacrylates, polyacrylamides, and polyacrylonitriles.

10. Copolymers of the monomers mentioned in 9. with one another or with other unsaturated monomers, e.g. acrylonitrile-butadiene copolymers, acrylonitrile-alkyl acrylate copolymers, acrylonitrile-alkoxyalkyl acrylate copolymers, acrylonitrile-vinyl halide copolymers, and acrylonitrile-alkyl methacrylate-butadiene terpolymers.

11. Polymers derived from unsaturated alcohols or amines and, respectively, their acyl derivatives or acetals, for example polyvinyl alcohol, polyvinyl acetate, polyvinyl stearate, polyvinyl benzoate, polyvinyl maleate, polyvinyl butyral, polyallyl phthalate, polyallylmelamine; and copolymers of these with olefins mentioned in 1.

12. Homo- and copolymers of cyclic ethers, for example polyalkylene glycols, polyethylene oxide, polypropylene oxide, and copolymers of these with bisglycidyl ethers.

13. Polyacetals, such as polyoxymethylene, and polyoxymethylenes which contain comonomers, e.g. ethylene oxide; polyacetals modified with thermoplastic polyurethanes, with acrylates, or with MBS.

14. Polyphenylene oxides and polyphenylene sulfides, and mixtures of these with styrene polymers or with polyamides.

15. Polyurethanes derived, on the one hand, from polyethers, polyesters, or polybutadienes having terminal hydroxyl groups and, on the other hand, from aliphatic or aromatic polyisocyanates, and also precursors of these polyurethanes.

16. Polyamides and copolyamides derived from diamines and dicarboxylic acids, and/or from aminocarboxylic acids, or from the corresponding lactams, for example nylon-4, nylon-6, nylon-6,6, -6,10, -6,9, -6,12, -4,6, -12,12, -11, and -12, aromatic polyamides, e.g. those based on p-phenylenediamine and adipic acid; polyamides prepared from hexamethylenediamine and iso- and/or terephthalic acid and, where appropriate, an elastomer as modifier, e.g. poly-2,4,4-trimethylhexamethyleneterephthalamide or poly-m-phenyleneisophthalamide. Other suitable polymers are block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol. EPDM- or ABS-modified polyamides or copolyamides are also suitable, as are polyamides condensed during processing (“RIM polyamide systems”).

17. Polyureas, polyimides, polyamideimides, polyetherimides, polyesterimides, polyhydantoins, and polybenzimidazoles.

18. Polyesters which derive from dicarboxylic acids and dialcohols and/or from hydroxycarboxylic acids, or from the corresponding lactones, for example polyethylene terephthalate, polybutylene terephthalate, poly-1,4-dimethylolcyclohexane terephthalate, polyhydroxybenzoates, and also block polyetheresters which derive from polyethers having hydroxyl end groups; polyesters modified with polycarbonates or with MBS.

19. Polycarbonates and polyester carbonates.

20. Polysulfones, polyether sulfones, and polyether ketones.

21. Crosslinked polymers which derive from aldehydes on the one hand and from phenols, urea or melamine on the other, for example phenol-formaldehyde resins, urea-formaldehyde resins, and melamine-formaldehyde resins.

22. Drying and nondrying alkyd resins.

23. Unsaturated polyester resins which derive from copolyesters of saturated or unsaturated dicarboxylic acids with polyhydric alcohols, and also vinyl compounds as crosslinkers, and also halogen-containing, flame-retardant modifications of these.

24. Crosslinkable acrylic resins which derive from substituted acrylic esters, e.g. from epoxyacrylates, from urethane acrylates, or from polyester acrylates.

25. Alkyd resins, polyester resins, and acrylate resins which have been crosslinked by melamine resins, by urea resins, by isocyanates, by isocyanurates, by polyisocyanates, or by epoxy resins.

26. Crosslinked epoxy resins which derive from aliphatic, cycloaliphatic, heterocyclic, or aromatic glycidyl compounds, e.g. products of bisphenol A diglycidyl ethers or of bisphenol F diglycidyl ethers, which are crosslinked by way of conventional hardeners, e.g. anhydrides or amines, with or without accelerators.

27. Natural polymers, such as cellulose (e.g. wood or cotton), natural rubber, gelatin, and also their polymer-homologous chemically modified derivatives, for example cellulose acetates, cellulose propionates, and cellulose butyrates and the cellulose ethers, such as methylcellulose; and colophony resins and derivatives.

28. Binary or multiple mixtures (polymer blends) of the abovementioned polymers are also very generally suitable, e.g. PP/EPDM, nylon/EPDM or ABS, PVC/EVA, PVC/ABS, PVC/MBS, PC/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/nylon-6,6 and copolymers, PA/HDPE, PA/PP, PA/PPO, PBT/PC/ABS, and PBT/PET/PC.

Preference is given to those particulate, linear, sheet-like or three-dimensional structures which encompass at least one polymeric material selected from the group consisting of polyolefins, polyesters, polyamides, polyacrylonitrile, polyaromatics, styrene-acrylonitrile copolymers (SAN), acrylonitrile-butadiene-styrene copolymers (ABS), polyurethanes, and mixtures (polymer blends) of the abovementioned polymers.

Preferred structures used according to the invention are synthetic fibers, particularly made from polyolefins, such as polyethylene or polypropylene, polyesters, polyacrylonitrile, or polyamides, e.g. nylon-6 or nylon-6,6.

Other preferred structures used according to the invention are sheet-like structures, and in particular supported or unsupported films. These preferably comprise a polymer selected from polyolefins, such as polyethylene and/or polypropylene, polymers of halogenated monomers, e.g. polyvinyl chloride, and/or polytetrafluoroethylene, polyesters, and mixtures of these.

Other preferred structures used according to the invention are moldings. These preferably comprise at least one polymeric material selected from polyolefins, e.g. polyethylene and/or polypropylene, polyaromatics, such as polystyrene, polymers of halogenated monomers, e.g. polyvinyl chloride and/or polytetra-fluoroethylene, polyesters, polyacrylonitrile, styrene-acrylo-nitrile copolymers, acrylonitrile-butadiene-styrene copolymers, polyamides, such as nylon-6 and/or nylon-6,6, polyurethanes, and mixtures of these.

According to the invention, at least one polyurethane polymer is used to modify the surface properties of the substrates. According to the invention, the term “polyurethane” encompasses not only those polymers whose repeat units are bonded to one another via urethane groups but also very generally polymers which are obtainable by reacting at least one di- and/or polyisocyanate with at least one compound which has at least one group reactive toward isocyanate groups. These include polymers whose repeat units are bonded by way of urea, allophanate, biuret, carbodiimide, amide, uretonimine, uretdione, isocyanurate, or oxazolidone(oxazolidinone) groups (see, for example, Kunststofftaschenbuch, Saechtling, 26th edn., pp. 491 et seq., Carl-Hanser-Verlag, Munich, 1995). The term “polyurethanes” encompasses in particular polymers which have urethane groups and/or urea groups.

Preference is given to polyurethanes whose weight-average molecular weight is in the range from about 500 to 100 000, preferably from 1 000 to 50 000.

Their content of urethane groups and/or urea groups (and, if present, other groups obtained by reacting an isocyanate group with a group reactive toward an isocyanate group and having an active hydrogen atom) is preferably in the range from 0.5 to 10 mol/kg, particularly preferably from 1 to 10 mol/kg, in particular from 2 to 8 mol/kg.

For the purposes of the present invention, the term “hyperbranched polymers” encompasses very generally polymers which have a branched structure and high functionality. For a general definition of hyperbranched polymers, reference is also made to P. J. Flory, J. Am. Chem. Soc. 1952, 74, 2718 and H. Frey et al., Chem. Eur. J. 2000, 6, No. 14, 2499. The hyperbranched polymers used according to the invention preferably have at least four other functional groups, besides urethane groups and/or urea groups (and other groups arising from the reaction of isocyanate groups). The content of functional groups is preferably from 4 to 100, particularly preferably from 5 to 30, and in particular from 6 to 20.

For the purposes of the invention, “hyperbranched polymers” also include star polymers, dendrimers (dendritic polymers), and high-molecular-weight polymers other than these, e.g. comb polymers.

“Star polymers” are polymers where three or more chains start from a center. This center may be a single atom or an atomic group. “Dendrimers” (dendritic polymers, cascade polymers, arborols, isotropically branched polymers, isobranched polymers, starburst polymers) are molecularly unitary macromolecules having a highly symmetrical structure. Structurally, dendrimers derived from star polymers, each of the individual chains in turn having star-type branching. They are produced from small molecules by way of a reaction sequence which constantly repeates, the result being constantly increasing levels of branching, each branch having terminal functional groups which in turn are a starting point for further branching. Each step of the reaction therefore increases exponentially the number of monomer end groups, and the final result here is a tree structure in the shape of a ball. One characteristic feature of dentrimers is the number of stages (generations) in the reaction for their preparation. Because dendrimers have a unitary structure they generally have a defined molar mass.

Other suitable polymers are “hyperbranched polymers” which are molecularly or structurally non-unitary, which have side chains of different length and level of branching, and which have a molar mass distribution.

The monomers known as ABₓ monomers are particularly suitable for synthesizing these hyperbranched polymers. These monomers have at least two different functional groups A and B, which can react with one another to form a link. In each molecule here there is only one functional group A, but two or more functional groups B. The reaction of said ABₓ monomers with one another produces non-crosslinked polymers with regularly arranged branching points. The chain ends of the polymers have almost exclusively B groups. Further details may be found in Journal of Molecular Science, Rev. Macromol. Chem. Phys., C37(3), 555-579 (1997), for example.

Hyperbranched polymers suitable according to the invention are described in WO 97/02304,U.S. Pat. No. 5,936,055, DE-A-100 13 187, DE-A-100 30 869, DE-A-199 04 444, and in the German patent application P 102 04 979.3, the entire scope of which is incorporated herein by way of reference.

The degree of branching (DB) of the hyperbranched polymers used according to the invention preferably corresponds to an average proportion of from 10 to 100%, preferably from 10 to 90%, and in particular from 10 to 80%, of dendritic links and terminal units per molecule. For a definition of “degree of branching”, reference is made to H. Frey et al., Acta Polym. 1997, 48, 30.

It is preferable to use hyperbranched polymers, i.e. polymers which are molecularly and structurally non-unitary. The preparation of these is generally simpler than that of dendrimers, and therefore more cost-effective. However, advantageous surface modification may, of course, also be obtained by using star polymers and dendrimeric polymers which are structurally and molecularly unitary.

One way of synthesizing hyperbranched polyurethanes and polyureas which may be used according to the invention is as described below.

To synthesize the hyperbranched polyurethanes and polyureas, it is preferable to use ABₓ monomers which have isocyanate groups, and also have groups which can react with isocyanate groups to form a link. x is a natural number from 2 to 8. x is preferably 2 or 3. Either A is the isocyanate groups and B is the groups reactive toward these, or vice versa.

The groups reactive toward the isocyanate groups are preferably OH, NH₂, NH, SH, or COOH groups.

The ABₓ monomers may be prepared in a known manner, using various methods.

For example, ABₓ monomers may be synthesized by the method disclosed in WO 97/02304, using protective-group techniques. This technique will be illustrated by way of example taking the reparation of an AB₂ monomer from 2,4-tolylene diisocyanate (TDI) and trimethylolpropane. First, one of the isocyanate groups of the TDI is capped in a known manner, for example by reacting with an oxime. The remaining free NCO group is reacted with trimethylolpropane, whereupon one of the three OH groups reacts with the isocyanate group. After cleavage of the protective group, the molecule obtained has an isocyanate group and 2 OH groups.

The ABₓ molecules may particularly advantageously be synthesized by the method disclosed in DE-A 199 04 444, in which no protective groups are required. In this method, di- or polyisocyanates are used, and are reacted with compounds which have at least two groups reactive toward isocyanate groups. At least one of the reaction partners has groups with differing reactivity toward the other reaction partner. Both reaction partners preferably have groups with differing reactivity toward the other reaction partner. The reaction conditions selected are such that only certain reactive groups can react with one another.

Another way of preparing ABₓ molecules is as described in the German patent application P 102 04 979.3. Here, isocyanate groups protected by a capping agent are reacted with polyamines to give polyureas.

The aliphatic, cycloaliphatic, araliphatic, or aromatic di- or polyisocyanates known from the prior art and described by way of example below may be used as di- or polyisocyanates. Preferred compounds which may be mentioned here are diphenylmethane 4,4′-diisocyanates, mixtures of monomeric diphenyl methane diisocyanates with oligomeric diphenylmethane diisocyanates (polymeric MDI), tetramethylene diisocyanate, tetramethylene diisocyanate trimers, hexamethylene diisocyanate, hexamethylene diisocyanate trimers, isophorone diisocyanate trimer, methylenebis(cyclohexyl) 4,4′-diisocyanate, xylylene diisocyanate, tetramethylxylylene diisocyanate, dodecyl diisocyanate, lysine alkyl ester diisocyanate, alkyl being C₁-C₁₀, 1,4-diisocyanatocyclohexane, or 4-isocyanatomethyloctamethylene 1,8-diisocyanate.

Di- or polyisocyanates which are particularly preferably suitable for synthesizing the polyurethanes and polyureas are those which have NCO groups of differing reactivity. Mention may be made here of tolylene 2,4-diisocyanate (2,4-TDI), diphenylmethane 2,4′-diisocyanate (2,4′-MDI), triisocyanatotoluene, isophorone diisocyanate (IPDI), 2-butyl-2-ethylpentamethylene diisocyanate, 2,2,4- or 2,4,4-trimethylhexamethylene 1,6-diisocyanate, 2-isocyanatopropylcyclohexyl isocyanate, 3(4)-isocyanatomethyl-1-methylcyclohexyl isocyanate, 1,4-diisocyanato-4-methylpentane, methylenebis(cyclohexyl) 2,4′-diisocyanate, and 4-methylcyclohexane 1,3-diisocyanate (HTDI).

Other isocyanates suitable for synthesizing the polyurethanes and polyureas are those whose NCO groups initially have the same reactivity but where a first addition reaction of a reactant to one NCO group can reduce the reactivity of the second NCO group. Examples of these are isocyanates whose NCO groups have coupling via a delocalized π-electron system, e.g. phenylene 1,3- and 1,4-diisocyanate, naphthylene 1,5-diisocyanate, diphenyl diisocyanate, tolidine diisocyanate, or tolylene 2,6-diisocyanate. Examples of other compounds which may be used are oligo- or polyisocyanates which can be prepared from the abovementioned di- or polyisocyanates or mixtures of these, through linking by means of urethane, allophanate, urea, biuret, uretdione, amide, isocyanurate, carbodiimide, uretonimine, oxadiazinetrione, or iminooxadiazinedione structures.

Preferred compounds which are used and have at least two groups reactive toward isocyanates are di-, tri-, or tetrafunctional compounds whose functional groups have differing reactivity toward NCO groups.

Preferred compounds for the preparation of polyurethanes and of polyurea polyurethanes are compounds having at least one primary and at least one secondary hydroxy group, having at least one hydroxy group and at least one mercapto group, and particularly preferably having at least one hydroxy group and at least one amino group in the molecule, in particular amino alcohols, amino diols, and amino triols, since the reactivity of the amino group is markedly higher than that of the hydroxy group in the reaction with isocyanate.

Examples of the compounds mentioned and having at least two groups reactive toward isocyanates are propylene glycol, glycerol, mercaptoethanol, ethanolamine, N-methylethanolamine, diethanolamine, ethanolpropanolamine, dipropanolamine, diisopropanolamine, 2-amino-1,3-propanediol, 2-amino-2-methyl-1,3-propanediol, and tris(hydroxymethyl)aminomethane. Mixtures of the compounds mentioned may also be used.

For the preparation of polyureas, it is preferable to use isocyanate-reactive products which have at least two amino groups in the molecule.

Examples of these are ethylenediamine, N-alkylethylenediamine, propylenediamine, N-alkylpropylenediamine, hexamethylenediamine, N-alkylhexamethylenediamine, diaminodicyclohexylmethane, phenylenediamine, isophoronediamine, amine-terminated polyoxyalkylene polyols (known as Jeffamine grades), bis(aminoethyl)amine, bis(aminopropyl)amine, bis(aminohexyl)-amine, tris(aminoethyl)amine, tris(aminopropyl)amine, tris(aminohexyl)amine, trisaminohexane, 4-aminomethyl-1,8-octa-methylenediamine, N′-(3-aminopropyl)-N,N-dimethyl-1,3-propane-diamine, trisaminononane, or melamine. Mixtures of the compounds mentioned may also be used.

An illustration will be given here by way of example of the preparation of an ABₓ molecule for preparing a polyurethane, from a diisocyanate and an aminodiol. Here, one mol of a diisocyanate is first reacted with one mol of an aminodiol at low temperatures, preferably in the range from −10 to 30° C. In this temperature range, there is practically complete suppression of the urethane-formation reaction, and the NCO groups of the isocyanate react exclusively with the amino group of the amino diol. The ABₓ molecule formed, in this case an AB₂ type, has one free NCO group, and also two free OH groups, and can be used for synthesizing a hyperbranched polyurethane.

Heating and/or addition of catalyst can cause this AB₂ molecule to react intermolecularly to give a hyperbranched polyurethane. The synthesis of the hyperbranched polyurethane may advantageously take place without prior isolation of the AB₂ molecule, in a further step of the reaction at an elevated temperature, preferably in the range from 30 to 80° C. When the AB₂ molecule described is used, this having two OH groups and one NCO group, the product is a hyperbranched polymer which has one free NCO group per molecule, and also—depending on the degree of polymerization—a varying number of OH groups. The reaction may be taken to high conversions, giving very high-molecular-weight structures. However, it may also be terminated once the desired molecular weight has been reached, for example by adding suitable monofunctional compounds, or by adding one of the starting compounds for preparing the AB₂ molecule. Depending on the starting compound used for termination, the product is either completely NCO-terminated or completely OH-terminated molecules. As an alternative, an AB₂ molecule may also be prepared from 1 mol of glycerol and 2 mol of 2,4-TDI, for example. At low temperature, the primary alcohol groups react preferentially, as does the isocyanate group in the 4-position, and the adduct formed has one OH group and two isocyanate groups and, as described, can be reacted at higher temperatures to give a hyperbranched polyurethane. The initial product is a hyperbranched polymer, which has one free OH group, and also—depending on the degree of polymerization—a varying number of NCO groups.

In principle, the hyperbranched polyurethanes and polyureas may be prepared without solvent, but they are preferably prepared in solution. Solvents suitable in principle are any of the compounds which are liquid at the reaction temperature and inert toward the monomers and toward the polymers.

Other products are obtainable by other variants of the synthesis. By way of example, mention may be made here of the following:

One way of obtaining AB₃ molecules is through reaction of diisocyanates with compounds having at least 4 groups reactive toward isocyanates. By way of example, mention may be made here of the reaction of tolylene diisocyanate with tris(hydroxymethyl)aminomethane.

To terminate the polymerization, use may also be made of polyfunctional compounds which can react with the respective groups A. This method can link two or more small hyperbranched molecules to give one large hyperbranched molecule.

One way of obtaining hyperbranched polyurethanes and polyureas with chain-extended branches is to carry out the polymerization reaction using not only the ABₓ molecules but also, in a molar ratio of 1:1, a diisocyanate and a compound which has two groups reactive toward isocyanate groups. These additional AA or BB compounds may also have other functional groups, but these must not be reactive toward the groups A or B under the conditions of the reaction. This method can introduce other functionalities into the hyperbranched polymer.

DE-A-100 13 187 and DE-A-100 30 869 give other suitable variants of the synthesis of hyperbranched polymers.

The hyperbranched polymers described above and having urethane groups and/or urea groups may generally be used as they stand for modifying the surface properties of substrates. Their surface-modifying properties depend on the functional groups introduced by the synthesis.

The hyperbranched polymers described above are preferably subjected to a polymer-analogous reaction prior to their use for modifying substrate surfaces. For example, the nature and amount of the compounds used for the polymer-analogous reaction can be used to adapt the properties of the polymer specifically for the respective application. Preference is therefore given to substrates as described above, where the hyperbranched polymer on the substrate surface is obtainable by polymer-analogous reaction between a hyperbranched polymer which bears urethane groups and/or urea groups, and/or other functional groups which are capable of a condensation reaction or addition reaction and at least one compound selected from
a) compounds which bear at least one functional group complementary to those groups of the hyperbranched polymer which are capable of a condensation reaction or addition reaction, where the compounds also bear at least a hydrophilic group,
b) compounds which bear at least one functional group complementary to those groups of the hyperbranched polymer which are capable of a condensation reaction or addition reaction, where the compounds also bear at least a hydrophobic group,
and mixtures of these.

For the purposes of the present invention, “complementary functional groups” are a pair of functional groups which can react with one another in a condensation reaction or addition reaction. “Complementary compounds” are pairs of compounds which have functional groups complementary to one another.

Preferred complementary functional groups for the hyperbranched polymers and for components a) and b) are those selected from the complementary functional groups in the overview below.

| Hyperbranched polymer | Components a, b |
|---|---|
| —NCO | —OH, —NHR, —SH, COOH |
| —NH—C(═O)—O— | —NCO, —NHR |
| —NH—C(═O)—NR— | —NCO |
| —OH, —NHR, —SH | —NCO, —COOR′, |
| | —C(═O)—O—C(═O)—, epoxide |
| | —NH—C(═O)—O—, |
| | —O—C(═O)—CR═CRR′ |

R and R′ have preferably been selected independently from hydrogen, alkyl, particularly preferably C₁-C₂₀-alkyl, such as methyl, ethyl, n-propyl, isopropyl, n-butyl, tert-butyl, the isomeric pentyls, hexyls, heptyls, octyls, etc., cycloalkyl, particularly preferably C₅-C₈-cycloalkyl, such as cyclopentyl and cyclohexyl, and aryl, particularly preferably phenyl, hetaryl, etc.

Examples of preferred complementary compounds are firstly compounds having active hydrogen atoms, e.g. selected from compounds having alcohol groups, primary and secondary amine groups, and thiol groups, and secondly compounds having groups reactive toward these, preferably isocyanate groups. It is generally unimportant here which functional group is borne by the polymer component and which functional group is borne by the compound a) and/or b).

Suitable hydrophilic groups for the compounds a) are those selected from ionogenic, ionic, and non-ionic hydrophilic groups. The ionogenic or ionic groups are preferably carboxylic acid groups and/or sulfonic acid groups, and/or nitrogen-containing groups (amines), or carboxylate groups, and/or sulfonate groups, and/or quaternized or protonated groups. Compounds a) which contain acid groups may be converted into the corresponding salts through partial or complete neutralization. Examples of suitable neutralizing bases are alkali metal bases, such as sodium hydroxide solution, potassium hydroxide solution, sodium carbonate, sodium hydrogen carbonate, potassium carbonate, or potassium hydrogen carbonate, and alkaline earth metal bases, such as calcium hydroxide, calcium oxide, magnesium hydroxide, or magnesium carbonate, or else ammonia, and amines, such as trimethylamine, triethylamine, etc. Compounds a) having amine nitrogen atoms can be used to generate charged cationic groups, either through protonation, e.g. using carboxylic acids, such as acetic acid, or through quaternization, e.g. using alkylating agents, such as C₁-C₄-alkyl halides or C₁-C₄-sulfates. Examples of these alkylating agents are ethyl chloride, ethyl bromide, dimethyl sulfate, and diethyl sulfate.

Hyperbranched polymers having ionic hydrophilic groups and obtainable through polymer-analogous reaction are generally water-soluble or water-dispersible.

Preferred components a) used are hydroxycarboxylic acids, such as hydroxy acetic acid (glycolic acid), hydroxypropionic acid (lactic acid), hydroxysuccinic acid (malic acid), hydroxypivalic acid, 4-hydroxybenzoic acid, 12-hydroxydodecanoic acid, dimethylolpropionic acid, etc.

Other preferred components a) used are hydroxysulfonic acids, such as hydroxymethanesulfonic acid or 2-hydroxyethanesulfonic acid.

Other preferred components a) used are mercaptocarboxylic acids, such as mercaptoacetic acid.

Other preferred components a) used are aminosulfonic acids of the formula:
R¹HN—Y—SO₃H
where

Y is o-, m-, or p-phenylene, or straight-chain or branched C₂-C₆-alkylene, where appropriate substituted by 1, 2, or 3 hydroxy groups, and

R¹ is a hydrogen atom, a C₁-C₁₂-alkyl group (preferably C₁-C₁₀-alkyl group and in particular C₁-C₆-alkyl group) or a C₅-C₆-cycloalkyl group, where the alkyl group or the cycloalkyl group may, where appropriate, have substitution by 1, 2, or 3 hydroxy groups, carboxy groups, or sulfonic acid groups.

The aminosulfonic acids of the above formula are preferably taurine, N-(1,1-dimethyl-2-hydroxyethyl)-3-amino-2-hydroxy-propanesulfonic acid, or 2-aminoethylaminoethanesulfonic acid.

Other preferred components a) used are α-, β-, or γ-aminoacids, such as glycine, alanine, valine, leucine, isoleucine, phenylalanine, thyrosine, proline, hydroxyproline, serine, threonine, methionine, cysteine, tryptophan, β-alanine, aspargic acid, or glutamic acid.

Other preferred components a) used are polyetherols. Suitable polyetherols are linear or branched substances having terminal hydroxy groups and containing ether bonds and having a molecular weight which is, for example, in the range from about 300 to 10 000. Examples of these include polyalkylene glycols, e.g. polyethylene glycols, polypropylene glycols, polytetrahydrofurans, copolymers of ethylene oxide, propylene oxide, and/or butylene oxide in which the alkylene oxide units present have random distribution or have been copolymerized in the form of blocks. Other suitable compounds are α,ω-diaminopolyethers obtainable by aminating polyetherols, using ammonia. Compounds of this type are commercially available with the name Jeffamine®.

Other preferred components a) are those selected from diamines, polyamines, and mixtures of these.

Suitable amines a) are straight-chain or branched, aliphatic or cycloaliphatic amines which generally have from about 2 to 30, preferably from about 2 to 20, carbon atoms. Examples of these include ethylenediamine, 1,2-diaminopropane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, diethylenetriamine, triethylenetetraamine, 4-azaheptamethylene-diamine, N,N′-bis(3-aminopropyl)butane-1,4-diamine, and mixtures of these. Suitable polyamines a) generally have a number-average molecular weight of from about 400 to 10 000, preferably from about 500 to 8 000. Examples of these include polyamides having terminal, primary or secondary amino groups, polyalkyleneimines, preference being given to polyethyleneimines and to vinylamines obtained through hydrolysis of poly-N-vinylamides, e.g. poly-N-vinylacetamide.

Other preferred components a) are those selected from polyols. Examples of these include diols having from 2 to 18 carbon atoms, preferably from 2 to 10 carbon atoms, e.g. 1,2-ethanediol, 1,3-propanediol, 1,4-butanediol, 1,6-hexanediol, 1,5-pentanediol, ,10-decanediol, 2-methyl-1,3-propanediol, 2-methyl-2-butyl-1,3-propanediol, 2,2-dimethyl-1,3-propanediol, 2,2-dimethyl-1,4-butanediol, 2-ethyl-2-butyl-1,3-propanediol, the neopentyl glycol ester of hydroxypivalic acid, diethylene glycol and triethylene glycol. Suitable triols and higher-functionality polyols are compounds having from 3 to 25, preferably from 3 to 18, particularly preferably from 3 to 6, carbon atoms. An example of a triol which may be used is glycerol or trimethylolpropane. Erythritol, pentaerythritol, and sorbitol are examples of higher-functionality polyols which may be used.

Other preferred components a) used are aminoalcohols. These preferably have from 2 to 16, particularly preferably from 3 to 12, carbon atoms, examples being monoethanolamine, methylisopropanolamine, ethylisopropanolamine, methylethanolamine, 3-aminopropanol, 1-ethylaminobutan-2-ol, diethanolamine, dipropanolamine, dibutanolamine, tris(hydroxymethyl)aminomethane, tris(hydroxyethyl)aminoethane, 4-methyl-4-aminopentan-2-ol and N-(2-hydroxyethyl)aniline, and mixtures of these.

Suitable hydrophobic groups for the compounds b) are those selected from saturated or unsaturated hydrocarbon radicals having from 8 to 40, preferably from 9 to 35, in particular from 10 to 30, carbon atoms. These are preferably alkyl, alkenyl, cycloalkyl, or aryl radicals. The cycloalkyl or aryl radicals may have 1, 2, or 3 substituents, preferably alkyl substituents or alkenyl substituents. For the purposes of the present invention, “alkenyl radicals” is the term used for radicals which have one, two, or more carbon-carbon double bonds.

For the purposes of the present invention, the expression C₈-C₄₀-alkyl encompasses straight-chain and branched alkyl groups. These are preferably straight-chain or branched C₉-C₃₅-alkyl groups, particularly preferably C₁₀-C₃₀-alkyl groups, and specifically C₁₂-C₂₆-alkyl groups. They are preferably the predominantly linear alkyl radicals also found in naturally occurring or synthetic fatty acids and in fatty alcohols, and also in oxo alcohols. They particularly include n-octyl, ethylhexyl, 1,1,3,3-tetramethylbutyl, n-nonyl, n-decyl, n-undecyl, n-dodecyl, n-tridecyl, myristyl, pentadecyl, palmityl (=cetyl), heptadecyl, octadecyl, nonadecyl, arrachinyl, behenyl, lignocerenyl, cerotinyl, melissinyl, etc.

C₈-C₄₀-Alkenyl is preferably straight-chain or branched alkenyl groups which may have single, double or multiple unsaturation. They are preferably C₉-C₃₅-alkenyl groups, particularly C₁₀-C₃₀-alkenyl groups and specifically C₁₂-C₂₆-alkenyl groups.

These particularly include octenyl, nonenyl, decenyl, undecenyl, dodecenyl, tridecenyl, tetradecenyl, pentadecenyl, hexadecenyl, heptadecenyl, octadecenyl, nonadecenyl, linolylyl, linolenylyl, eleostearyl, etc., and in particular oleyl (9-octadecenyl).

The compound of the formula b) is then preferably alkylamines, such as 1-octylamine, 1-nonylamine, 1-decylamine, 1-undecylamine, 1-undec-10-enylamine, 1-tridecylamine, 1-tetradecylamine, 1-pentadecylamine, 1-hexadecylamine, 1-heptadecylamine, 1-octadecylamine, 1-octadeca-9,12-dienylamine, 1-nonadecylamine, 1-eicosylamine, 1-eicos-9-enylamine, 1-heneicosylamine, 1-docosylamine, and in particular oleylamine and 1-hexadecylamine (cetylamine), or amine mixtures prepared from naturally occurring fatty acids, e.g. tallow fatty amines, which predominantly contain saturated and unsaturated C₁₄, C₁₆-C₁₈-alkylamines, or cocamines, which contain saturated, and singly and doubly unsaturated C₈-C₂₂-alkylamines, preferably C₁₂-C₁₄-alkylamines.

Other preferred compounds b) are those selected from monohydric alcohols which have one of the abovementioned hydrophobic radicals. These alcohols and alcohol mixtures b) are obtainable, for example, through hydrogenation of fatty acids from naturally occurring fats and oils, or of synthetic fatty acids, e.g. from the catalytic oxidation of paraffins. Suitable alcohols and alcohol mixtures b) are also obtainable through hydroformylation of olefins with simultaneous hydrogenation of the aldehydes, the results generally being mixtures of straight-chain and branched primary alcohols (oxo alcohols). Suitable alcohols and alcohol mixtures b) are also obtainable through partial oxidation of n-paraffins by known processes, giving predominantly linear secondary alcohols. The substantially primary, straight-chain, and even-numbered Ziegler alcohols obtainable through synthesis using organoaluminum compounds are also suitable.

Examples of suitable monohydric alcohols b) are octanol, nonanol, decanol, undecanol, dodecanol, tridecanol, tetradecanol, pentadecanol, hexadecanol, heptadecanol, octadecanol, etc., and mixtures of these.

Examples of suitable monoisocyanates b) are C₈-C₄₀-alkyl isocyanates which are obtainable from the abovementioned amines and amine mixtures through phosgenation, or from naturally occurring or synthetic fatty acids and fatty acid mixtures through Hofmann, Curtius, or Lossen degradation.

Each of the abovementioned compounds a) and b) may be used alone, or in the form of a mixture of exclusively hydrophilic compounds a), or of exclusively hydrophobic compounds b), or else in the form of a mixture of hydrophilic compounds a) with hydrophobic compounds b). The surface-modifying properties of the hyperbranched polymers may be varied within a wide range by polymer-analogous reaction of hyperbranched polymers bearing urethane groups and/or urea groups with individual compounds a) or b), or with a mixture of these. This method can give the substrates modified using these polymers surface properties which extend from strong affinity toward water and aqueous liquids (hydrophilic properties) through very low affinity toward water and aqueous liquids (hydrophobic properties).

Some further embodiments of polymer-analogous reactions are indicated below:

Hyperbranched polyurethanes which have polymerizable olefinic groups, and which can be used for the preparation of radiation-crosslinking, in particular UV-crosslinking, polymers may be obtained through reaction with compounds containing acrylate groups, e.g. alcohols containing acrylate groups, for example 2-hydroxyethyl acrylate or 2-hydroxyethyl methacrylate. Epoxide groups or vinyl ether groups which can be utilized for cationically crosslinking polymers may be introduced through reaction with appropriately substituted alcohols.

Oxidatively drying hyperbranched polyurethanes or polyureas may be obtained by reacting polymers containing NCO groups or urethane groups with mono- or polyunsaturated fatty esters which have at least one OH group, or with mono- or polyunsaturated fatty alcohols, or with fatty amines, in particular those having from 3 to 40 carbon atoms. For example, esters which contain OH groups and derive from linoleic acid, linolenic acid, or eleostearic acid may be reacted with NCO groups. NCO groups or urethane groups may moreover also be reacted directly with amines or alcohols containing vinyl or allyl groups.

One way of preparing hyperbranched polyurethanes or polyureas which have different types of functionalities is to react 2 mols of 2,4-TDI with a mixture of 1 mol of trimethylolpropane and 1 mol of dimethylolpropionic acid. The product obtained here has carboxylic acid groups and also has OH groups.

Another way of obtaining these products is to carry out a polymerization using an ABₓ molecule, to terminate the polymerization at the desired conversion, and then to convert only a portion of the functional groups originally present, for example only a portion of the OH groups or NCO groups. In an example of this method, in the case of an NCO-terminated polymer made from 2,4-TDI and glycerol, for example, a portion of the NCO groups may be reacted with ethanolamine, and the remaining NCO groups may be reacted with mercaptoacetic acid.

Subsequent hydrophobicization of an OH-terminated polymer made from isophorone diisocyanate and diethanolamine is also possible, for example by using dodecyl isocyanate or dodecanoic acid to convert a portion of the OH groups. The change in functionalization of a hyperbranched polyurethane, or the adaptation of the polymer properties to the required application may advantageously take place immediately following the polymerization reaction, without prior isolation of the NCO-terminated polyurethane. However, the functionalization may also take place in a separate reaction.

The hyperbranched polymers according to the invention may be used in mixtures or in combination with other surface-active substances. These include conventional anionic, non-ionic, or cationic surfactants and, respectively, wetting agents. The hyperbranched polymers used according to the invention may, if desired, also be used in combination with the other polymers conventionally used for modifying the surface properties of substrates. In particular cases this type of combination can increase the surface-modifying effect.

The hyperbranched polyurethanes used according to the invention and having urethane groups and/or urea groups are advantageously suitable for modifying the surface properties of substrates. These may generally take the form of particulate, linear, sheet-like, or three-dimensional structures. The term “modifying the surface properties” is widely interpreted for the purposes of the present invention. It particularly includes altering the affinity of the surface for water and water-containing liquids, in comparison to that of an unmodified surface. The hyperbranched polymers used according to the invention encompass firstly polymers which improve the affinity with respect to water of a surface treated therewith (hydrophilicized), and secondly polymers which reduce the affinity for water of a surface treated therewith (hydrophobicized). A suitable measure for assessing the hydrophilic/hydrophobic properties of the surface of a substrate is measurement of the contact angle of water on the respective surface (see, for example, Römpp, Chemielexikon, 9th edn., p. 372 “Benetzung”, Georg-Thieme-Verlag (1995)). According to the invention, a “hydrophobic surface” is a surface on which the contact angle of water is >90°. A “hydrophilic surface” is a surface on which the contact angle with water is ≦90°. Surfaces treated with hydrophilicizing hyperbranched polymers have a smaller contact angle than the unmodified surface. The contact angle reduction brought about by a hydrophilicizing hyperbranched polymer is preferably at least 10°, with preference at least 30°, when compared with that of the unmodified surface. Surfaces treated with hydrophobicizing hyperbranched polymers have a larger contact angle than the unmodified surface. The contact angle increase brought about by a hydrophobicizing hyperbranched polymer is preferably at least 10°, with preference at least 30°, when compared with that of the unmodified surface.

The reduction found in the surface tension of water is advantageously substantially smaller when using the substrates of the invention whose surface bears a hydrophilicizing hyperbranched polymer than when using commercially available surfactants. The reason for this is that, in contrast to commercially available polymers, it is almost impossible for the polymers used to be dissolved out from the surface and to lower the surface tension. Nor is any undesired tendency toward migration generally observed. The hyperbranched polymers used according to the invention remain on the treated surfaces, even on rinsing with water or aqueous liquids, and thus can provide longlasting hydrophilic modification. The reduction in surface tension with respect to water when using surfaces modified with hydrophilicizing hyperbranched polymers is generally at most 30%, particularly preferably at most 20%, and in particular at most 10%, when comparison is made with the unmodified surface.

The substrates of the invention modified using hydrophilicizing hyperbranched polymers generally absorb liquid faster and/or absorb more liquid, and/or have improved liquid retention, generally also at superatmospheric pressure.

The hydrophilicized substrates of the invention are generally advantageously suitable for any of the application sectors where water or aqueous liquids come into contact with materials which in their unmodified state are substantially hydrophobic. These include in particular the rapid absorption and/or rapid transport of water into materials which per se are hydrophobic. The structures of the invention may moreover generally be used with advantage wherever improved adhesion properties, improved antistatic properties, improved antifogging properties, improved hand, and/or improved wearer comfort can be achieved through the hydrophilic modification of surfaces.

The hydrophilicized substrates of the invention are advantageously suitable in, or in the form of, synthetic fibers, wovens, knits, nonwoven fabrics, felts, textile composites, e.g. carpets, laminated textiles, etc. They are also advantageously suitable for use in diapers, hygiene inserts, cleaning cloths and wipers, dishcloths, napkins, agricultural textiles, and/or geotextiles, and also for filter applications.

The hydrophilic, hyperbranched polymers used according to the invention are suitable as hydrophilicizing agents for the abovementioned materials, in particular for synthetic fibers, such as those made from polyethylene, polypropylene, polyesters, polyacrylonitrile, or polyamides. The polymers are also suitable for improving the printability and adhesive-bondability of supported or unsupported films, for example those made from polyethylene, polypropylene, polyvinyl chloride, polytetrafluoroethylene, or polyesters.

The antistatic properties of supported or unsupported films may moreover be improved by using the hydrophilic, hyperbranched polymers.

When the hydrophilic, hyperbranched polymers are used with moldings, the result is again an improvement in surface properties, giving these better printability or adhesive-bondability, and better antistatic properties. Examples of typical moldings are those composed of polyethylene, polypropylene, polystyrene, polyvinyl chloride, polytetrafluoroethylene, polyesters, polyacrylonitrile, styrene-acrylonitrile copolymers (SAN), acrylonitrile-butadiene-styrene terpolymers (ABS), polyamides, such as nylon-6 or nylon-6,6, polyurethanes, and/or a mixture of the abovementioned plastics.

The use of hydrophilic, hyperbranched polymers having urethane groups and/or urea groups moreover improves the surface conductivity of hydrophobic, non-conducting materials, in particular of the abovementioned plastics, thus improving their antistatic properties. The hydrophilic, hyperbranched polymers are also suitable for reducing the fogging tendency of plastic films.

The usual processes applied to the hydrophilicization or hydrophobicization of the abovementioned structures, using hydrophilicizing agents or hydrophobicizing agents, respectively, of the prior art may be used to equip the substrates of the invention in the form of particulate, linear, sheet-like, or three-dimensional structures, with the hyperbranched polymers. To this end, the structure is usually treated with a dilute, preferably aqueous solution of the polymer in a manner conventional for the nature of the structure, e.g. by splashing, dipping, spraying, padding, or the similar methods usually used for treating textile webs or films. The polymer content of the solutions is generally in the range from at least 0.01 to 20% by weight, preferably from 0.1 to 10% by weight, based on the weight of the solution. The treatment preferably uses aqueous solutions of the polymers. The amount of polymer needed for the hydrophilicization or hydrophobicization is absorbed or adsorbed by the surface and remains adhering thereto after drying. The amounts required to achieve effective hydrophilicization or hydrophobicization are therefore achieved automatically, and are extremely small. In the case of structures with a smooth surface, e.g. films and similar structures, amounts as small as 0.1 mg/m² of polymer are sufficient.

In another embodiment of the process of the invention for the hydrophilicization or hydrophobicization of surfaces, the polymer may also be added to the material of which the structure is composed, the structure then being produced therefrom. For example, when modifying thermoplastics, the polymer in the form of a solid may be compounded with the plastic. The resultant modified plastic is then further processed by the usual processes to give films, for example by extrusion, or to give fiber materials, for example by a melt-spinning process.

The ease of use of the polymers of the invention and of the polymers used according to the invention permits use in many application sectors, for example in the form of a hydrophilicizing agent for nonwoven fabrics, used in diapers, hygiene inserts, agricultural textiles, or geotextiles, or filter systems, for example. The synthetic fibers modified using the polymers may in turn be further processed to give textiles. The hydrophilicization or hydrophobicization generally also improves water-vapor permeability and capillary transport of sweat, and also improves soiling performance with respect to a wide variety of hydrophobic types of dirt. There is also a favorable effect on dirt-release properties. The polymers may also be used to provide antistatic properties to plastic films or to silicon wafers.

### EXAMPLES

### Examples 1 to 4

### Hyperbranched Polymers of the Invention

Preparation of Polyureas and Polyurethanes

### Examples 1 and 2: Polyureas of the Invention

10 mol of anhydrous butanol formed an initial charge, under dry nitrogen gas, in a reaction vessel with stirrer, internal thermometer, and nitrogen inlet pipe, and 1 000 ppm (based on isocyanate) of dibutyltin dilaurate were added. The solution was then heated to 60° C, and 1 mol of tolylene 2,4-diisocyanate was added in such a way as to prevent the temperature of the reaction mixture from exceeding 70° C. After addition of the isocyanate, stirring was continued at 70° C. for 1 h. The amount stated in table 1 of the amine or of the amine mixture was then added, and the temperature was increased to the value stated in table 1, and the reaction was allowed to proceed at that temperature for the period stated in the table. The reaction product was then freed from butanol in vacuo on a rotary evaporator, cooled to room temperature, and analyzed using GPC analysis.

In example 1, OH groups were used for hydrophilic modification of the polyurea, while in example 2 alkyl chains were used for hydrophobic modification of the polyurea.

TABLE 1
Polyureas of the invention

| | | | Product, molecular | |
|---|---|---|---|---|
| | | | weight from GPC data | |
| | | | (PMMA calibration), | |
| | | | dimethylacetamide as | |
| Exam- | | Time and | mobile phase | |
| ple | Amine mixture | temperature | Mw | Mn |
| 1 | 0.5 mol | 20 h at | 2 330 | 1 700 |
| | diethylenetriamine + | 125° C. | | |
| | 0.5 mol diethanolamine | | | |
| 2 | 0.45 mol | 7 h at | 3 110 | 1 940 |
| | diethylenetriamine + | 125° C. | | |
| | 0.5 mol octylamine | | | |

### Example 3

### Polyurea of the Invention

1 mol of isophorone diisocyanate formed an initial charge in a reaction vessel with stirrer, internal thermometer, and reflux condenser, and the vessel was inertized using dry nitrogen, and the isocyanate was heated to 70° C. 1 000 ppm (based on isocyanate) of dibutyltin dilaurate were then added, and 2.1 mol of butanol were added dropwise in such a way as to prevent the internal temperature from rising above 80° C. Once the alcohol had been added, stirring was continued at 70° C. for 1 h, and then 0.5 mol of diethylenetriamine was added, and the temperature was increased to 140° C. After 8 h of reaction at 140° C., the product mixture was freed from butanol on a rotary evaporator. GPC analysis of the product in dimethylacetamide against PMMA calibration gave the following values:
Mn=1 050 g/mol, M_{w}=1 870 g/mol

### Example 4

### Polyurethane of the Invention

1 mol of isophorone diisocyanate formed an initial charge at room temperature in a reaction vessel with stirrer, internal thermometer, and reflux condenser, and the vessel was inertized using dry nitrogen. The mixture of 0.5 mol of trimethylolpropane and 0.5 mol of dimethylolpropionic acid, dissolved in 356 g of dimethylacetamide, was then added, with thorough stirring, within 1 min. After 0.4 g of dibutyltin dilaurate had been metered in, the reaction mixture was heated to 60° C. and stirred at this temperature, and the fall-off in isocyanate content of the mixture was followed by a titrimetric method to DIN 53185. Once an NCO content of 0.7% by weight had been reached, 50 g of ethanol were added to the mixture, which was stirred for a further 30 min at 60° C. The reaction mixture was then freed from solvent on a rotary evaporator. The product was taken up in water and neutralized with aqueous ammonia solution to give a 50% strength aqueous solution of the polymer.

### Examples 5 to 10

Modification of Surfaces

### Example 5

A 50% strength solution of the hyperbranched polyurea from example 2 in ethanol is doctored onto an untreated PP film at a layer thickness of 30 μm. After drying at 50° C., the contact angle of an applied water droplet is determined.
Contact angle: 27°
PP film (for comp.): 103°

### Example 6

A 50% strength solution of the hyperbranched polyurea from example 1 in ethanol is doctored onto an untreated PP film at a layer thickness of 30 μm. After drying at 50° C., the contact angle of an applied water droplet is determined.
Contact angle: 9°
PP film (for comp.) 103°

### Example 7

A 50% strength solution of the hyperbranched polyurea from example 3 in ethanol was doctored onto an untreated PP film at a layer thickness of 30 μm. After drying at 50° C., the contact angle of an applied water droplet was determined. The film could not be washed off using water.
Contact angle: 37°
PP film (for comp.) 103°

### Example 8

A 50% strength solution of the hyperbranched polyurethane from example 4 was doctored onto an untreated PP film at a layer thickness of 30 μm. After drying at 50° C., the contact angle of an applied water droplet was determined. The film could not be washed off using water.
Contact angle: 69°
PP film (for comp.) 103°

### Example 9

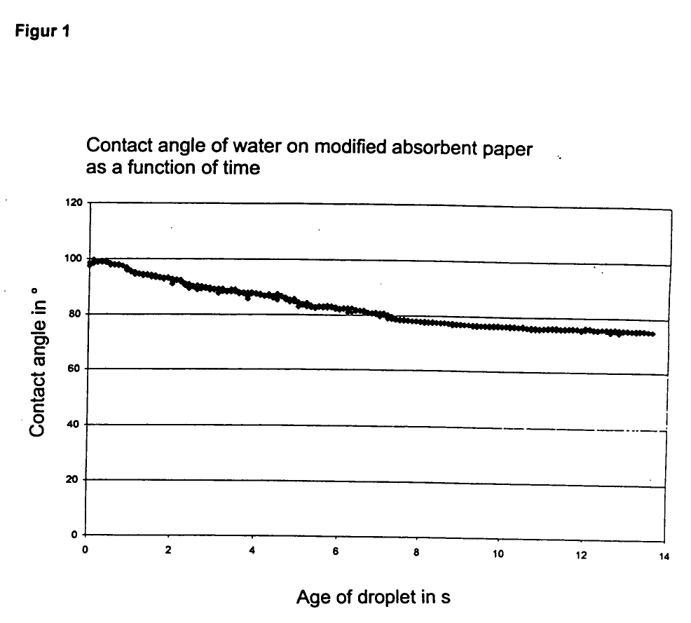

Pieces of hydrophilic blotting paper from the company Schleicher & Schuell (grade 2282) are dipped into a 5% strength solution of the hyperbranched polyurea from example 1 in ethanol. The pieces of paper are then allowed to dry in air at room temperature. The absorption behavior of applied water droplets is followed, using the dataphysics OCA15+ CA tester. It is illustrated in FIG. 1.

An untreated piece of blotting paper absorbs an applied water droplet within one second.

### Example 10

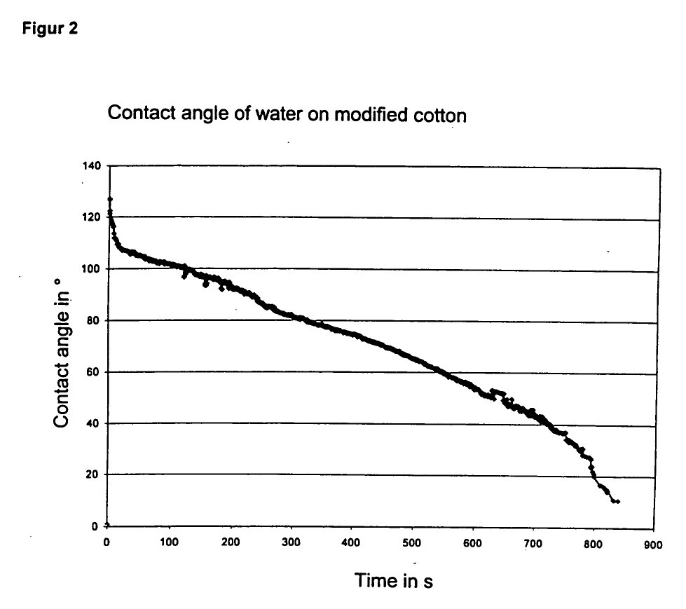

The hyperbranched polymer from example 2 is diluted to 20% polymer content, using ethanol. Pieces of cotton were saturated in this solution and pressed dry in a laboratory press. After the drying process, the degree of coating was determined. The degree of coating was 24%, based on the weight of the fabric. The absorption behavior of water on the fabric was then observed. The fabric was stored in daylight at room temperature for 10 days, and absorption behavior was then checked, using the dataphysics OCA15+ CA tester. It is illustrated in FIG. 2.

An untreated piece of cotton fabric absorbs an applied water droplet within one second.

1. A substrate whose surface comprises at least one hyperbranched polymer which has urethane groups and/or urea groups.

2. A substrate as claimed in claim 1 in the form of a particulate, linear, sheet-like, or three-dimensional structure.

3. A substrate as claimed in claim 2 in the form of a linear or sheet-like textile.

4. A substrate as claimed in claim 3 in which the textile is composed of synthetic fibers.

5. A substrate as claimed in claim 2 in which the structure has the form of a plastic film or of a plastic molding.

6. A substrate as claimed in claim 1 wherein the hyperbranched polymer has a degree of branching (DB) of from 10 to 100%.

7. A substrate as claimed in claim 1 wherein the hyperbranched polymer on the substrate surface is obtained by polymer-analogous reaction between a hyperbranched polymer which bears urethane groups and/or urea groups, and/or other functional groups which are capable of a condensation reaction or addition reaction and at least one compound selected from the group consisting of:
a) compounds which bear at least one functional group complementary to those groups of the hyperbranched polymer which are capable of a condensation reaction or addition reaction, where the compounds also bear at least a hydrophilic group;
b) compounds which bear at least one functional group complementary to those groups of the hyperbranched polymer which are capable of a condensation reaction or addition reaction, where the compounds also bear at least a hydrophobic group;
and mixtures of these thereof.

8. (cancel)

9. A process for modifying the surface properties of substrates, comprising applying an effective amount of a hyperbranched polymer which bears urethane groups and/or urea groups to the surface of a substrate.

10. A process for modifying the surface properties of substrates, comprising treating a material of which a substrate is composed is with an effective amount of a hyperbranched polymer which has urethane groups and/or urea groups.
